(19) United States
(12) Patent Application Publication
(10) Pub. No.: US 2025/0300499 A1
(43) Pub. Date: Sep. 25, 2025

(54) COMMUNICATION APPARATUS, OPTICAL POWER SUPPLY SYSTEM AND OPTICAL POWER SUPPLY METHOD

(71) Applicant: NIPPON TELEGRAPH AND TELEPHONE CORPORATION, Tokyo (JP)

(72) Inventors: Ryota KITA, Musashino-shi, Tokyo (JP); Yoichi FUKADA, Musashino-shi, Tokyo (JP); Hiroaki KATSURAI, Musashino-shi, Tokyo (JP); Masayoshi SEKIGUCHI, Musashino-shi, Tokyo (JP); Tomoaki YOSHIDA, Musashino-shi (JP)

(73) Assignee: NIPPON TELEGRAPH AND TELEPHONE CORPORATION, Tokyo (JP)

(21) Appl. No.: 18/863,129

(22) PCT Filed: Sep. 26, 2022
(86) PCT No.: PCT/JP2022/035670

§ 371 Date: Nov. 5, 2024

(30) Foreign Application Priority Data
May 17, 2022 (WO) PCT/JP2022/020497

(51) Int. Cl. H02J 50/30

(52) U.S. Cl. CPC H02J 50/30

(57) ABSTRACT

A communication device includes: a power feeding light transmission unit that transmits power feeding light to an opposing communication device; a measurement unit that measures an optical loss value in transmission of the power feeding light from an own device to the opposing communication device; and a control unit that controls output of the power feeding light transmitted from the power feeding light transmission unit according to the optical loss value measured by the measurement unit.

### TECHNICAL FIELD

The present invention relates to a communication device, an optical power feeding system, and an optical power feeding method.

The present application claims priority on the basis of PCT/JP2022/020497 filed in Japan on May 17, 2022, the contents of which are incorporated herein by reference.

### BACKGROUND ART

Conventionally, there has been an optical communication system in which a communication device on a power feeding side on which an optical power feeding light source is mounted and a communication device on a power receiving side on which a photoelectric converter is mounted are connected to each other by wire to perform optical power feeding and communication (see Non Patent Literature 1, for example). In such an optical communication system, power is supplied to the communication device on the power receiving side by power feeding light transmitted from the optical power feeding light source of the communication device on the power feeding side. The communication device on the power receiving side accumulates the received power in the secondary power supply, and is driven by the accumulated power.

### CITATION LIST

### Non Patent Literature

Non Patent Literature 1: “2. Yusen kyuden access system no kosei (in Japanese) (Configuration of wired power supply access system)”, ANSL R&D Times, No. 105, NTT Access Network Service Systems Laboratories website, December 2018, [searched on Sep. 13, 2022], Internet (URL: https://www.rd.ntt/as/times/1May 2, 2002.html)

Non Patent Literature 2: “OTDR sokutei no tameno kiso chisiki (in Japanese) (Basic knowledge for OTDR measurement)”, NTT Rental Engineering Co., Ltd. website, 2015, [searched on Sep. 13, 2022], Internet (URL: https://www.nttrec.co.jp/faq/faq-product/faq-hikarisokutei/faq-hikarisokutei05)

### SUMMARY OF INVENTION

### Technical Problem

However, in the conventional optical communication system, regardless of the situation such as the installation location and the accumulated power amount of the communication device on the power receiving side, the communication device on the power feeding side supplies power with a constant output by the optical power feeding light source. Therefore, in the conventional optical communication system, there has been a problem that excessive power supply may be performed depending on the situation of the communication device.

In view of the above circumstances, an object of the present invention is to provide a technology that can reduce power consumption of an optical power feeding light source.

### Solution to Problem

One aspect of the present invention is a communication device including: a power feeding light transmission unit that transmits power feeding light to an opposing communication device; a measurement unit that measures an optical loss value in transmission of the power feeding light from an own device to the opposing communication device; and a control unit that controls output of the power feeding light transmitted from the power feeding light transmission unit according to the optical loss value measured by the measurement unit.

Further, one aspect of the present invention is an optical power feeding system including a first communication device and a second communication device, in which: the first communication device includes a power feeding light transmission unit that transmits power feeding light to the second communication device, a measurement unit that measures an optical loss value in transmission of the power feeding light from the first communication device to the second communication device, and a control unit that controls output of the power feeding light transmitted from the power feeding light transmission unit according to the optical loss value measured by the measurement unit; and the second communication device includes a power feeding light reception unit that receives the power feeding light transmitted from the first communication device, a photoelectric conversion unit that converts the power feeding light received by the power feeding light reception unit into power, and a power storage unit that stores the power converted by the photoelectric conversion unit.

Further, one aspect of the present invention is an optical power feeding method including: a power feeding light transmission step of transmitting power feeding light to an opposing communication device; a measurement step of measuring an optical loss value in transmission of the power feeding light from an own device to the opposing communication device; and a control step of controlling output of the power feeding light according to the optical loss value measured by the measurement step.

Further, one aspect of the present invention is an optical power feeding method in an optical power feeding system including a first communication device and a second communication device, the optical power feeding method including: a power feeding light transmission step in which the first communication device transmits power feeding light to the second communication device; a measurement step in which the first communication device measures an optical loss value in transmission of the power feeding light from the first communication device to the second communication device; a control step in which the first communication device controls output of the power feeding light according to the optical loss value measured by the measurement step; a power feeding light reception step in which the second communication device receives the power feeding light transmitted from the first communication device; a photoelectric conversion step in which the second communication device converts the power feeding light received by the power feeding light reception step into power; and a power storage step in which the second communication device stores the power converted by the photoelectric conversion step.

### Advantageous Effects of Invention

According to the present invention, it is possible to reduce power consumption of an optical power feeding light source.

### BRIEF DESCRIPTION OF DRAWINGS

FIG. 1 is a block diagram illustrating an overall configuration of an optical communication system 8.

FIG. 2 is a block diagram illustrating an overall configuration of an optical communication system 1 according to a first embodiment of the present invention.

FIG. 3 is a flowchart illustrating the operation of the optical communication system 1 according to the first embodiment of the present invention.

FIG. 4 is a block diagram illustrating an overall configuration of an optical communication system 1a according to a second embodiment of the present invention.

FIG. 5 is a flowchart illustrating the operation of the optical communication system 1a according to the second embodiment of the present invention.

FIG. 6 is a block diagram illustrating an overall configuration of an optical communication system 1b according to a third embodiment of the present invention.

FIG. 7 is a block diagram illustrating an overall configuration of an optical communication system 1c according to a fourth embodiment of the present invention.

FIG. 8 is a block diagram illustrating an overall configuration of an optical communication system 1d according to a fifth embodiment of the present invention.

FIG. 9 is a flowchart illustrating the operation of a communication device 11d according to the fifth embodiment of the present invention.

FIG. 10 is a flowchart illustrating the operation of the communication device 11d according to the fifth embodiment of the present invention.

### DESCRIPTION OF EMBODIMENTS

Hereinafter, a communication device, an optical power feeding system, and an optical power feeding method according to the present invention will be described with reference to the drawings.

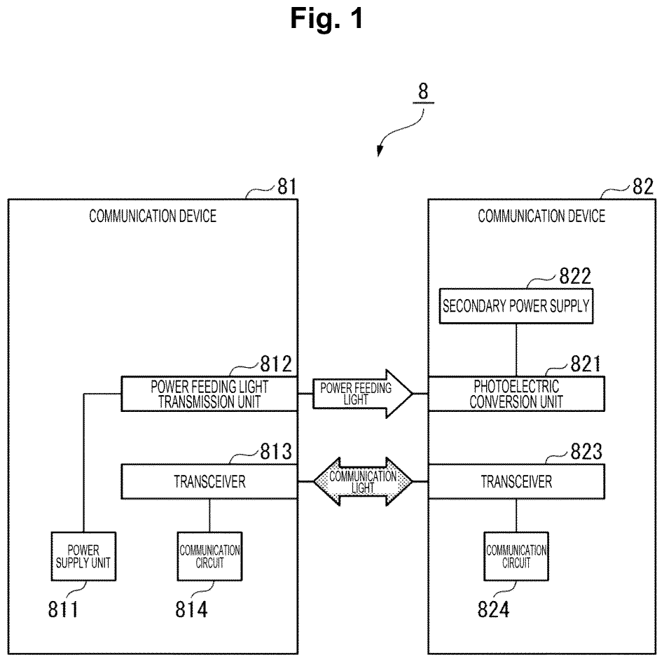

In order to make features of the optical power feeding system and the optical power feeding method of the present invention easier to understand, first, a configuration of a general optical power feeding system as a comparative example will be described. FIG. 1 is a block diagram illustrating an overall configuration of an optical communication system 8. The optical communication system 8 is an example of an optical power feeding system as a comparative example. As illustrated in FIG. 1, the optical communication system 8 includes a communication device 81 and a communication device 82. The communication device 81 and the communication device 82 are connected by wire, and can transmit and receive data by transmitting and receiving communication light to and from each other.

Furthermore, the communication device 81 and the communication device 82 are connected by wire, and power feeding light output from the communication device 81 is input to the communication device 82. That is, the communication device 81 is a communication device on the power feeding side on which an optical power feeding light source is mounted, and the communication device 82 is a communication device on the power receiving side on which a photoelectric converter is mounted.

As illustrated in FIG. 1, the communication device 81 includes a power supply unit 811, a power feeding light transmission unit 812, a transceiver 813, and a communication circuit 814.

The power supply unit 811 is a light source power supply for generating the power feeding light transmitted from the power feeding light transmission unit 812. The power feeding light transmission unit 812 transmits power feeding light to the communication device 82. The transceiver 813 is a transceiver that transmits and receives communication light between the own device and the communication device 82. The communication circuit 814 controls the transceiver 813 to transmit and receive data between the own device and the communication device 82 using communication light.

Furthermore, as illustrated in FIG. 1, the communication device 82 includes a photoelectric conversion unit 821, a secondary power supply 822, a transceiver 823, and a communication circuit 824.

The photoelectric conversion unit 821 receives the power feeding light transmitted from the communication device 81. The photoelectric conversion unit 821 converts the received power feeding light into power. The secondary power supply 822 stores the power converted by the photoelectric conversion unit 821. Each functional unit of the communication device 82 is driven by power stored in the secondary power supply 822. The transceiver 823 is a transceiver that transmits and receives communication light between the own device and the communication device 81. The communication circuit 824 controls the transceiver 823 to transmit and receive data between the own device and the communication device 81 using communication light.

With such a configuration, in the conventional optical communication system 8, the communication device 82 can be driven and data communication between the communication device 81 and the communication device 82 can be achieved by the power feeding light transmitted from the communication device 81 to the communication device 82. However, in the conventional optical communication system 8, the communication device 81 transmits the power feeding light from the power feeding light transmission unit 812 with a constant output and supplies power to the communication device 82. Therefore, depending on, for example, the situation such as the installation location and the accumulated power amount of the communication device 82 on the power receiving side, excessive power supply may be performed.

### First Embodiment

Hereinafter, an optical communication system 1 according to a first embodiment of the present invention will be described. The optical communication system 1 is an example of an optical power feeding system of the present invention.

The optical communication system 1 is a system in which a communication device on a power feeding side on which an optical power feeding light source is mounted and a communication device on a power receiving side on which a photoelectric converter is mounted are connected to each other by wire to perform optical power feeding and communication. The optical communication system 1 measures the optical loss value of the power feeding light transmitted from the communication device on the power feeding side to the communication device on the power receiving side. In general, the optical loss value varies depending on the situation (for example, a distance from the communication device on the power feeding side, and the like) such as an installation location of the communication device on the power receiving side on which the photoelectric converter is mounted.

Then, the optical communication system 1 is characterized by controlling the power of the power feeding light output from the optical power feeding light source of the communication device on the power feeding side on the basis of the measured optical loss value. At this time, the optical communication system 1 controls the intensity of the power of the power feeding light transmitted from the optical power feeding light source, so that the power of the power feeding light input to the photoelectric converter of the communication device on the power receiving side does not become equal to or greater than a predetermined value. In addition, the optical communication system 1 performs control to switch on and off the output of the power feeding light transmitted from the optical power feeding light source according to the charge state of the secondary power supply of the communication device on the power receiving side. With such a characteristic, the optical communication system 1 according to the first embodiment can reduce the power consumption of the optical power feeding light source.

### [Configuration of Optical Communication System]

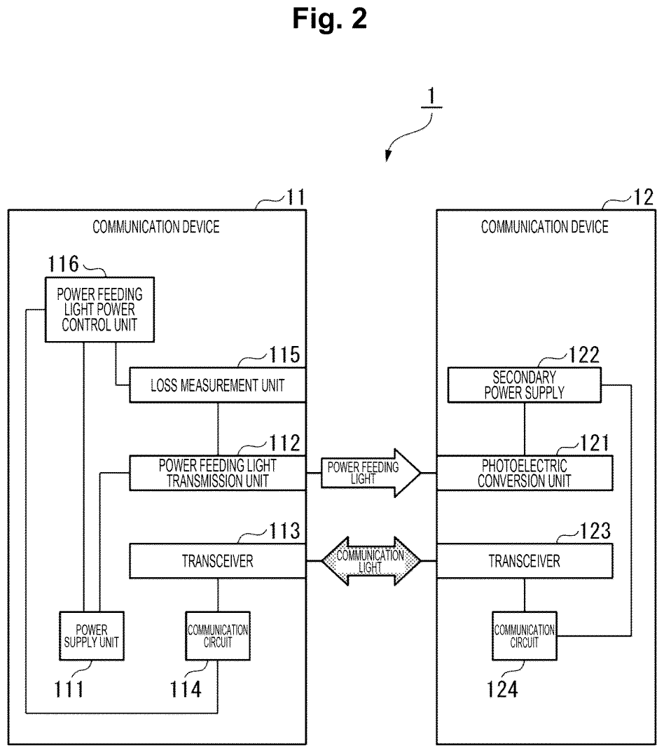

Hereinafter, the configuration of the optical communication system 1 will be described in more detail. FIG. 2 is a block diagram illustrating an overall configuration of an optical communication system 1 according to the first embodiment of the present invention. As illustrated in FIG. 2, the optical communication system 1 includes a communication device 11 and a communication device 12. The communication device 11 and the communication device 12 are connected by wire, and transmit and receive data by transmitting and receiving communication light to and from each other. The communication device 11 and the communication device 12 are connected by, for example, an optical fiber cable for communication, and communication light is transmitted via the optical fiber cable for communication.

Note that the communication cable may be a cable other than the optical fiber cable. Furthermore, the communication device 11 and the communication device 12 may be wirelessly communicably connected.

Furthermore, the communication device 11 and the communication device 12 are connected by wire, and the power feeding light output from the communication device 11 is input to the communication device 12. That is, the communication device 11 is a communication device on the power feeding side on which an optical power feeding light source is mounted, and the communication device 12 is a communication device on the power receiving side on which a photoelectric converter is mounted. The communication device 11 and the communication device 12 are connected by a power supply optical fiber cable different from the above-described optical fiber cable for communication, and the power feeding light is transmitted via the power supply optical fiber cable.

As illustrated in FIG. 2, the communication device 11 includes a power supply unit 111, a power feeding light transmission unit 112, a transceiver 113, a communication circuit 114, a loss measurement unit 115, and a power feeding light power control unit 116. The communication device 11 is, for example, an optical line terminal (OLT) installed on a station side of a communication company in a passive optical network (PON) type subscriber line network (public line network) using an optical fiber. The communication device 11 is an example of the communication device of the present invention.

The power supply unit 111 is a light source power supply for generating the power feeding light transmitted from the power feeding light transmission unit 112. The power feeding light transmission unit 112 transmits power feeding light to the communication device 12. The power feeding light transmission unit 112 is, for example, a laser diode. The transceiver 113 is a transceiver that transmits and receives communication light between the own device and the communication device 12. The communication circuit 114 controls the transceiver 113 to transmit and receive data between the own device and the communication device 12 using communication light.

The loss measurement unit 115 measures the optical loss value of the power feeding light transmitted from the communication device 11 to the communication device 12. The loss measurement unit 115 outputs information indicating the measured optical loss value to the power feeding light power control unit 116. For example, the loss measurement unit 115 measures the optical loss value of the power feeding light when the communication device 11 and the communication device 12 are connected. Alternatively, for example, the loss measurement unit 115 measures the optical loss value of the power feeding light at predetermined intervals (for example, every hour or every day).

Note that any existing technology can be used as a method of measuring the optical loss value of the power feeding light. For example, the loss measurement unit 115 measures the optical loss value using an optical time domain reflectometer (OTDR). As a method for measuring the optical loss value using the OTDR, for example, a technology described in Non Patent Literature 2 can be used.

For example, the loss measurement unit 115 measures the distance from the communication device 11 on the power feeding side to the communication device 12 on the power receiving side by the OTDR. Then, the loss measurement unit 115 calculates the optical loss value by multiplying the measured distance by the optical loss per unit. Alternatively, for example, the loss measurement unit 115 directly measures the optical loss value of the power feeding light between the communication device 11 and the communication device 12 by the OTDR.

The power feeding light power control unit 116 acquires information indicating the optical loss value output from the loss measurement unit 115. The power feeding light power control unit 116 controls the power of the power feeding light transmitted from the power feeding light transmission unit 112 by controlling the power supply unit 111 according to the acquired optical loss value. At this time, the power feeding light power control unit 116 curbs the power of the power feeding light to be transmitted from the power feeding light transmission unit 112, so that the power of the power feeding light input to the communication device 12 on the power receiving side does not become equal to or greater than a predetermined value.

For example, as the optical loss value of the power feeding light between the communication device 11 and the communication device 12 is larger, it is conceivable that the installation location of the communication device 12 on the power receiving side is farther away from the location of the communication device 11 on the power feeding side. Therefore, the power feeding light power control unit 116 controls the power supply unit 111 so that the power of the power feeding light transmitted from the power feeding light transmission unit 112 becomes larger as the acquired optical loss value is larger. Conversely, the power feeding light power control unit 116 controls the power supply unit 111 so that the power of the power feeding light transmitted from the power feeding light transmission unit 112 becomes smaller as the acquired optical loss value is smaller.

Note that the value of the power of the power feeding light transmitted from the power feeding light transmission unit 112 is predetermined for each optical loss value. For example, a table in which the optical loss value and the power value of the power feeding light are associated with each other is stored in advance in a storage medium (not illustrated) provided in the communication device 11. The power feeding light power control unit 116 refers to the table and acquires the power value of the power feeding light corresponding to the acquired optical loss value. Then, the power feeding light power control unit 116 controls the power supply unit 111 so that the power of the power feeding light transmitted from the power feeding light transmission unit 112 has the acquired value.

Furthermore, as illustrated in FIG. 2, the communication device 12 includes a photoelectric conversion unit 121, a secondary power supply 122, a transceiver 123, and a communication circuit 124. The communication device 12 is, for example, an optical network unit (ONU) installed at a subscriber's home in a PON type subscriber line network (public line network) using an optical fiber.

The photoelectric conversion unit 121 receives the power feeding light transmitted from the communication device 11. The photoelectric conversion unit 121 converts the received power feeding light into power. The photoelectric conversion unit 121 is, for example, a photodiode. The secondary power supply 122 stores the power converted by the photoelectric conversion unit 121. Each functional unit of the communication device 12 is driven by power stored in the secondary power supply 122. The secondary power supply 122 includes, for example, a battery. The transceiver 123 is a transceiver that transmits and receives communication light between the own device and the communication device 11. The communication circuit 124 controls the transceiver 123 to transmit and receive data between the own device and the communication device 11 using communication light.

Further, the secondary power supply 122 periodically (for example, every minute or every hour) outputs information indicating its own charge state to the communication circuit 124. Note that the communication circuit 124 may be configured to be able to periodically detect the charge state of the secondary power supply 122.

When fully charged, the secondary power supply 122 outputs information indicating the fully charged state to the communication circuit 124. Then, the communication circuit 124 notifies the communication device 11 that the secondary power supply 122 is fully charged. Specifically, the communication circuit 124 transmits information (hereinafter referred to as “full charge notification”) indicating that the secondary power supply 122 is fully charged to the communication device 11 via the transceiver 123 by communication light.

The communication circuit 114 of the communication device 11 acquires the full charge notification transmitted from the communication device 12 on the power receiving side via the transceiver 113. When acquiring the full charge notification, the communication circuit 114 outputs the full charge notification to the power feeding light power control unit 116. The power feeding light power control unit 116 acquires the full charge notification output from the communication circuit 114. When acquiring the full charge notification, the power feeding light power control unit 116 controls the power supply unit 111 to stop the transmission of the power feeding light to the communication device 12 by the power feeding light transmission unit 112. As a result, power supply to the communication device 12 is stopped.

In addition, when the remaining charge amount is equal to or less than a predetermined value, the secondary power supply 122 outputs information indicating that the remaining charge amount is equal to or less than the predetermined value to the communication circuit 124. The communication circuit 124 notifies the communication device 11 that the remaining charge amount of the secondary power supply 122 is equal to or less than the predetermined value. Specifically, the communication circuit 124 transmits information (hereinafter referred to as “remaining charge amount reduction notification”.) indicating that the remaining charge amount of the secondary power supply 122 is equal to or less than the predetermined value to the communication device 11 via the transceiver 123 by communication light.

The communication circuit 114 of the communication device 11 acquires the remaining charge amount reduction notification transmitted from the communication device 12 on the power receiving side via the transceiver 113. When acquiring the remaining charge amount reduction notification, the communication circuit 114 outputs the remaining charge amount reduction notification to the power feeding light power control unit 116. The power feeding light power control unit 116 acquires the remaining charge amount reduction notification output from the communication circuit 114. When acquiring the remaining charge amount reduction notification, the power feeding light power control unit 116 controls the power supply unit 111 to resume the transmission of the power feeding light to the communication device 12 by the power feeding light transmission unit 112. As a result, power supply to the communication device 12 is resumed.

### [Operation of Optical Communication System]

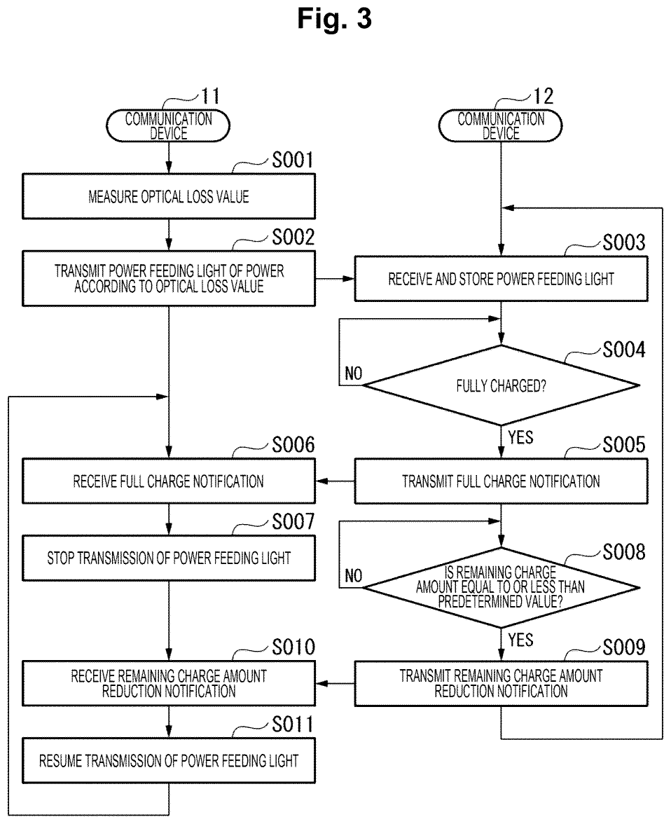

Hereinafter, an example of the operation of the optical communication system 1 will be described. FIG. 3 is a flowchart illustrating the operation of the optical communication system 1 according to the first embodiment of the present invention. The operation of the optical communication system 1 illustrated in the flowchart of FIG. 3 is started, for example, when the communication device 11 and the communication device 12 are connected.

The loss measurement unit 115 of the communication device 11 on the power feeding side measures the optical loss value of the power feeding light transmitted from the communication device 11 to the communication device 12 (step S001). The loss measurement unit 115 outputs information indicating the measured optical loss value to the power feeding light power control unit 116. The power feeding light power control unit 116 controls the power supply unit 111 according to the acquired optical loss value to perform control such that power feeding light of power according to the optical loss value is transmitted from the power feeding light transmission unit 112 (step S002).

The photoelectric conversion unit 121 of the communication device 12 on the power receiving side receives the power feeding light transmitted from the communication device 11. The photoelectric conversion unit 121 converts the received power feeding light into power. The secondary power supply 122 stores the power converted by the photoelectric conversion unit 121 (step S003).

When fully charged (step S004), the secondary power supply 122 outputs information indicating the fully charged state to the communication circuit 124. The communication circuit 124 transmits a full charge notification to the communication device 11 by communication light via the transceiver 123 (step S005).

The communication circuit 114 of the communication device 11 on the power feeding side receives the full charge notification transmitted from the communication device 12 on the power receiving side via the transceiver 113 (step S006). The communication circuit 114 outputs the full charge notification to the power feeding light power control unit 116. When acquiring the full charge notification, the power feeding light power control unit 116 controls the power supply unit 111 to stop the transmission of the power feeding light to the communication device 12 by the power feeding light transmission unit 112 (step S007).

When the remaining charge amount is equal to or less than a predetermined value (step S008: YES), the secondary power supply 122 of the communication device 12 on the power receiving side outputs information indicating that the remaining charge amount is equal to or less than the predetermined value to the communication circuit 124. The communication circuit 124 transmits a remaining charge amount reduction notification to the communication device 11 by communication light via the transceiver 123 (step S009).

The communication circuit 114 of the communication device 11 on the power feeding side receives the remaining charge amount reduction notification transmitted from the communication device 12 on the power receiving side via the transceiver 113 (step S010). The communication circuit 114 outputs the remaining charge amount reduction notification to the power feeding light power control unit 116. When acquiring the remaining charge amount reduction notification, the power feeding light power control unit 116 controls the power supply unit 111 to resume the transmission of the power feeding light by the power feeding light transmission unit 112 (step S011).

The operation of the optical communication system 1 illustrated in the flowchart of FIG. 3 ends, for example, when communication between the communication device 11 and the communication device 12 ends.

As described above, in the optical communication system 1 according to the first embodiment, the communication device 11 on the power feeding side on which the optical power feeding light source is mounted and the communication device 12 on the power receiving side on which the photoelectric converter is mounted are connected to each other by wire to perform optical power feeding and communication. The optical communication system 1 measures the optical loss value of the power feeding light transmitted from the communication device 11 to the communication device 12. Then, the optical communication system 1 controls the power of the power feeding light output from the optical power feeding light source of the communication device 11 on the basis of the measured optical loss value. At this time, the optical communication system 1 controls the intensity of the power of the power feeding light transmitted from the optical power feeding light source, so that the power of the power feeding light input to the photoelectric converter of the communication device on the power receiving side does not become equal to or greater than a predetermined value.

In addition, as described above, in the optical communication system 1 according to the first embodiment, the communication device 12 notifies the communication device 11 of the charge state of the secondary power supply 122 of the communication device 12 using communication light. Then, the optical communication system 1 performs control to switch on and off the output of the power feeding light transmitted from the optical power feeding light source according to the charge state of the secondary power supply 122 of the communication device 12.

With such a characteristic, the optical communication system 1 according to the first embodiment can reduce the power consumption of the optical power feeding light source.

### Second Embodiment

Hereinafter, an optical communication system 1a according to a second embodiment of the present invention will be described. The optical communication system 1a is an example of an optical power feeding system of the present invention. Unlike the optical communication system 1 in the first embodiment described above, in the optical communication system 1a, the communication device on the power receiving side notifies the communication device on the power feeding side of the charge state of the secondary power supply by using reflected light of the power feeding light instead of communication light.

Note, however, that when the power feeding light is not transmitted from the communication device on the power feeding side to the communication device on the power receiving side, reflected light of the power feeding light does not exist either. As a result, the communication device on the power receiving side cannot notify the communication device on the power feeding side of the charge state of the secondary power supply using reflected light. Therefore, in this case, similarly to the optical communication system 1 according to the first embodiment described above, the optical communication system 1a according to the second embodiment uses communication light for notification of the charge state of the secondary power supply. With such a characteristic, the optical communication system 1a according to the second embodiment can reduce the power consumption of the optical power feeding light source.

### [Configuration of Optical Communication System]

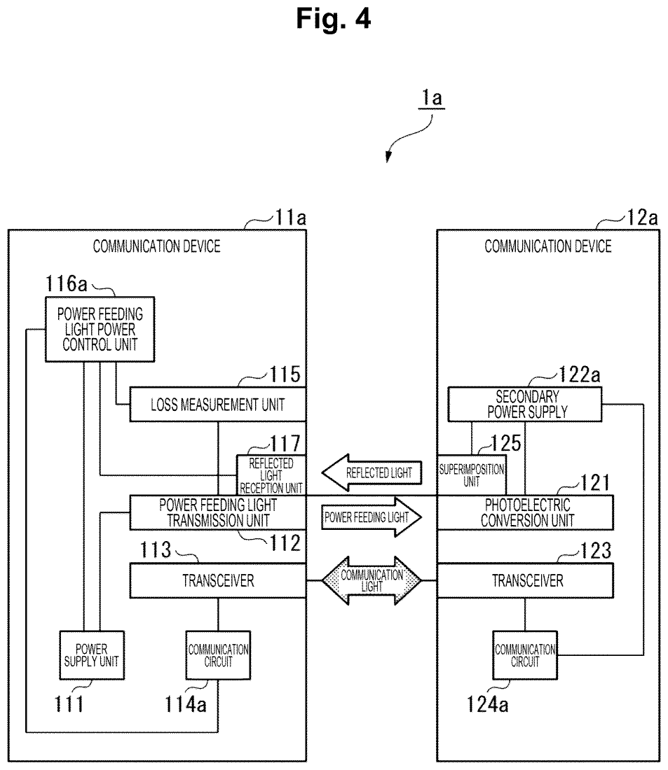

Hereinafter, the configuration of the optical communication system 1a will be described in more detail. FIG. 4 is a block diagram illustrating an overall configuration of the optical communication system 1a according to the second embodiment of the present invention. As illustrated in FIG. 4, the optical communication system 1a includes a communication device 11a and a communication device 12a. The communication device 11a and the communication device 12a are connected by wire, and transmit and receive data by transmitting and receiving communication light to and from each other. The communication device 11a and the communication device 12a are connected by, for example, an optical fiber cable for communication, and communication light is transmitted via the optical fiber cable for communication.

Note that the communication cable may be a cable other than the optical fiber cable. Furthermore, the communication device 11a and the communication device 12a may be wirelessly communicably connected.

Furthermore, the communication device 11a and the communication device 12a are connected by wire, and the power feeding light output from the communication device 11a is input to the communication device 12a. That is, the communication device 11a is a communication device on the power feeding side on which an optical power feeding light source is mounted, and the communication device 12a is a communication device on the power receiving side on which a photoelectric converter is mounted. The communication device 11a and the communication device 12a are connected by a power supply optical fiber cable different from the above-described optical fiber cable for communication, and the power feeding light is transmitted via the power supply optical fiber cable.

Note that, in the following description, among functional units included in the optical communication system 1a according to the second embodiment, functional units having functions similar to those of the optical communication system 1 according to the first embodiment described above are denoted by the same reference numerals, and description thereof may be omitted.

As illustrated in FIG. 4, the communication device 11a includes a power supply unit 111, a power feeding light transmission unit 112, a transceiver 113, a communication circuit 114a, a loss measurement unit 115, a power feeding light power control unit 116a, and a reflected light reception unit 117. The communication device 11a is, for example, an OLT. The communication device 11a is an example of the communication device of the present invention.

The power supply unit 111 is a light source power supply for generating the power feeding light transmitted from the power feeding light transmission unit 112. The power feeding light transmission unit 112 transmits power feeding light to the communication device 12a. The transceiver 113 is a transceiver that transmits and receives communication light between the own device and the communication device 12a. The communication circuit 114a controls the transceiver 113 to transmit and receive data between the own device and the communication device 12a using communication light.

The loss measurement unit 115 measures the optical loss value of the power feeding light transmitted from the communication device 11a to the communication device 12a. The loss measurement unit 115 outputs information indicating the measured optical loss value to the power feeding light power control unit 116a. For example, the loss measurement unit 115 measures the optical loss value of the power feeding light when the communication device 11a and the communication device 12a are connected. Alternatively, for example, the loss measurement unit 115 measures the optical loss value of the power feeding light at predetermined intervals (for example, every hour or every day). Note that any existing technology can be used as a method of measuring the optical loss value of the power feeding light.

The power feeding light power control unit 116a acquires the information indicating the optical loss value output from the loss measurement unit 115. The power feeding light power control unit 116a controls the power of the power feeding light transmitted from the power feeding light transmission unit 112 by controlling the power supply unit 111 according to the acquired optical loss value. The power feeding light power control unit 116a curbs the power of the power feeding light transmitted from the power feeding light transmission unit 112, so that the power of the power feeding light input to the communication device 12a on the power receiving side does not become equal to or greater than a predetermined value.

The reflected light reception unit 117 receives the reflected light of the power feeding light transmitted from the power feeding light transmission unit 112. As described above, the reflected light is the reflected light with respect to the power feeding light transmitted from the power feeding light transmission unit 112 to the communication device 12a. A notification regarding the charge state of the secondary power supply 122a of the communication device 12a is superimposed on the reflected light. The reflected light reception unit 117 demodulates the reflected light and acquires a notification regarding the charge state of a secondary power supply 122a. The reflected light reception unit 117 includes, for example, a demodulator, and is provided side by side with the power feeding light transmission unit 112. The reflected light reception unit 117 outputs the acquired notification regarding the charge state of the secondary power supply 122a to the power feeding light power control unit 116a.

As a type of notification regarding the charge state of the secondary power supply 122a superimposed on the reflected light, for example, there is a full charge notification. Note that the full charge notification does not necessarily need to be information indicating that the secondary power supply 122a is actually fully charged, and may be, for example, information indicating that the secondary power supply 122a is in a state where the remaining charge amount is equal to or greater than a predetermined value (that is, information indicating that a sufficient remaining charge amount has been reached). Note that, as a type of notification regarding the charge state of the secondary power supply 122a superimposed on the reflected light, for example, there may be a remaining charge amount reduction notification.

The power feeding light power control unit 116a acquires the notification regarding the charge state of the secondary power supply 122a output from the reflected light reception unit 117. The power feeding light power control unit 116a controls the power of the power feeding light transmitted from the power feeding light transmission unit 112 by controlling the power supply unit 111 according to the acquired notification regarding the charge state of the secondary power supply 122a.

The power feeding light power control unit 116a acquires the full charge notification output from the reflected light reception unit 117. When acquiring the full charge notification, the power feeding light power control unit 116a controls the power supply unit 111 to stop the transmission of the power feeding light to the communication device 12a by the power feeding light transmission unit 112. As a result, power supply to the communication device 12a is stopped.

Note that the power feeding light power control unit 116a may acquire the remaining charge amount reduction notification output from the reflected light reception unit 117. Then, when acquiring the remaining charge amount reduction notification, the power feeding light power control unit 116 may control the power supply unit 111 to make the power of the power feeding light transmitted to the communication device 12a by the power feeding light transmission unit 112 stronger. As a result, more appropriate power supply to the communication device 12a is performed.

Furthermore, as illustrated in FIG. 4, the communication device 12a includes a photoelectric conversion unit 121, a secondary power supply 122a, a transceiver 123, a communication circuit 124a, and a superimposition unit 125. The communication device 12a is, for example, an ONU.

The photoelectric conversion unit 121 receives power feeding light transmitted from the communication device 11a. The photoelectric conversion unit 121 converts the received power feeding light into power. The secondary power supply 122a stores the power converted by the photoelectric conversion unit 121. The transceiver 123 is a transceiver that transmits and receives communication light between the own device and the communication device 11a. The communication circuit 124a controls the transceiver 123 to transmit and receive data between the own device and the communication device 11a using communication light.

In addition, the secondary power supply 122a outputs information indicating its own charge state to the superimposition unit 125 periodically (for example, every minute or every hour). Note that the superimposition unit 125 may be configured to be able to periodically detect the charge state of the secondary power supply 122a.

The superimposition unit 125 acquires information indicating the charge state of the secondary power supply 122a from the secondary power supply 122a. The superimposition unit 125 superimposes a part of the power feeding light received by the photoelectric conversion unit 121 on the reflected light of the power feeding light by modulating the notification regarding the charge state of the secondary power supply 122a. The superimposition unit 125 includes, for example, a reflective modulator, and is provided side by side with the photoelectric conversion unit 121. The superimposition unit 125 transmits the reflected light on which the notification regarding the charge state of the secondary power supply 122a is superimposed to the communication device 11a.

For example, when fully charged, the secondary power supply 122a outputs information indicating the fully charged state to the superimposition unit 125. Then, the superimposition unit 125 superimposes the full charge notification indicating that the secondary power supply 122a is fully charged on the reflected light of the power feeding light by modulating the full charge notification. The superimposition unit 125 transmits the reflected light on which the full charge notification of the secondary power supply 122a is superimposed to the communication device 11a.

In addition, when the remaining charge amount is empty (0), the secondary power supply 122a outputs information indicating that the remaining charge amount is empty to the communication circuit 124a. Note that the communication circuit 124a may be configured to be able to detect that the remaining charge amount of the secondary power supply 122a is empty.

The communication circuit 124a notifies the communication device 11a that the remaining charge amount of the secondary power supply 122a is empty. Specifically, the communication circuit 124a transmits information (hereinafter referred to as “overdischarge notification”) indicating that the remaining charge amount of the secondary power supply 122a is empty to the communication device 11a via the transceiver 123 by communication light.

Note that the overdischarge notification does not necessarily need to be information indicating that the secondary power supply 122 is actually empty, and may be information indicating that the secondary power supply 122 is in a state where the remaining charge amount is equal to or less than a predetermined value (that is, information indicating that the remaining charge amount has become insufficient).

The communication circuit 114a of the communication device 11a on the power feeding side acquires the overdischarge notification transmitted from the communication device 12a on the power receiving side via the transceiver 113. The communication circuit 114a outputs the overdischarge notification to the power feeding light power control unit 116a. When acquiring the overdischarge notification, the power feeding light power control unit 116a controls the power supply unit 111 to resume the transmission of the power feeding light to the communication device 12a by the power feeding light transmission unit 112. As a result, power supply to the communication device 12a is resumed.

Note that the case where the remaining charge amount of the secondary power supply 122a of the communication device 12a is empty is assumed to be a case where power is not supplied from the communication device 11a to the communication device 12a. In a case where the power feeding light is not transmitted from the communication device 11a to the communication device 12a, since there is no reflected light of the power feeding light, the overdischarge notification cannot be superimposed on the reflected light and transmitted from the communication device 12a to the communication device 11a. Therefore, the overdischarge notification is transmitted from the communication device 12a to the communication device 11a using communication light.

### [Operation of Optical Communication System]

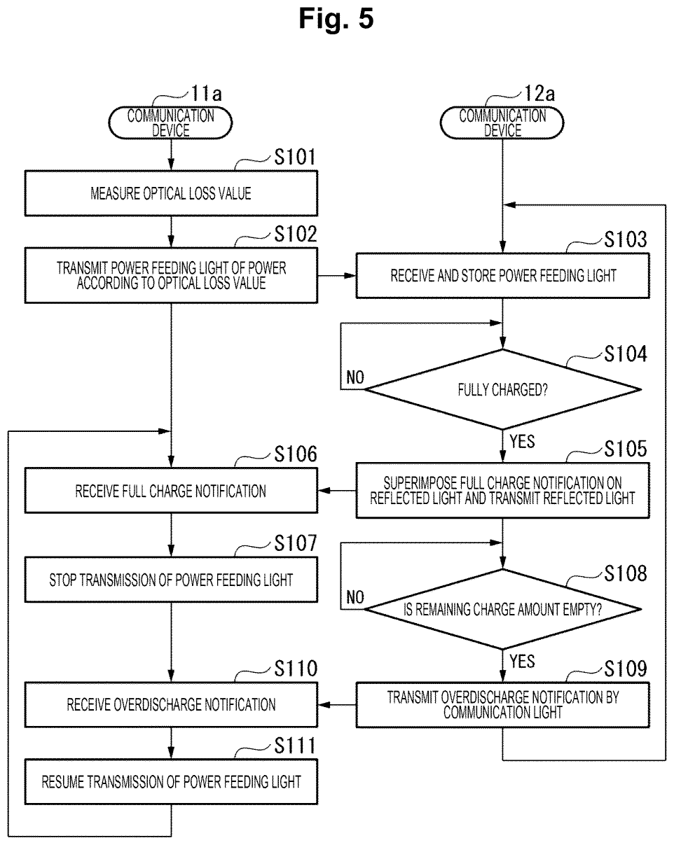

Hereinafter, an example of the operation of the optical communication system 1a will be described. FIG. 5 is a flowchart illustrating the operation of the optical communication system 1a according to the second embodiment of the present invention. The operation of the optical communication system 1a illustrated in the flowchart of FIG. 5 is started, for example, when the communication device 11a and the communication device 12a are connected.

The loss measurement unit 115 of the communication device 11a on the power feeding side measures the optical loss value of the power feeding light transmitted from the communication device 11a to the communication device 12a (step S101). The loss measurement unit 115 outputs information indicating the measured optical loss value to the power feeding light power control unit 116a. The power feeding light power control unit 116a controls the power supply unit 111 according to the acquired optical loss value to perform control such that power feeding light of power according to the optical loss value is transmitted from the power feeding light transmission unit 112 (step S102).

The photoelectric conversion unit 121 of the communication device 12a on the power receiving side receives the power feeding light transmitted from the communication device 11a. The photoelectric conversion unit 121 converts the received power feeding light into power. The secondary power supply 122a stores the power converted by the photoelectric conversion unit 121 (step S103).

When fully charged (step S104: YES), the secondary power supply 122a outputs information indicating the fully charged state to the superimposition unit 125. Then, the superimposition unit 125 superimposes the full charge notification on the reflected light of the power feeding light by modulating the full charge notification. The superimposition unit 125 transmits the reflected light on which the full charge notification is superimposed to the communication device 11a (step S105).

The reflected light reception unit 117 of the communication device 11a on the power feeding side receives the reflected light of the power feeding light transmitted from the power feeding light transmission unit 112. The reflected light reception unit 117 demodulates the reflected light and acquires a full charge notification (step S106). The reflected light reception unit 117 outputs the acquired full charge notification to the power feeding light power control unit 116a. When acquiring the full charge notification, the power feeding light power control unit 116a controls the power supply unit 111 to stop the transmission of the power feeding light to the communication device 12a by the power feeding light transmission unit 112 (step S107).

When the remaining charge amount is empty (step S108: YES), the secondary power supply 122a of the communication device 12a on the power receiving side outputs information indicating that the remaining charge amount is empty to the communication circuit 124a. The communication circuit 124a transmits an overdischarge notification to the communication device 11a by communication light via the transceiver 123 (step S109).

The communication circuit 114a of the communication device 11a on the power feeding side receives the overdischarge notification transmitted from the communication device 12a on the power receiving side via the transceiver 113 (step S110). The communication circuit 114a outputs the overdischarge notification to the power feeding light power control unit 116a. When acquiring the overdischarge notification, the power feeding light power control unit 116a controls the power supply unit 111 to resume the transmission of the power feeding light to the communication device 12a by the power feeding light transmission unit 112 (step S111).

The operation of the optical communication system 1a illustrated in the flowchart of FIG. 5 ends, for example, when communication between the communication device 11a and the communication device 12a ends.

As described above, in the optical communication system 1a according to the second embodiment, the communication device 11a on the power feeding side on which the optical power feeding light source is mounted and the communication device 12a on the power receiving side on which the photoelectric converter is mounted are connected to each other by wire to perform optical power feeding and communication. The optical communication system 1a measures the optical loss value of the power feeding light transmitted from the communication device 11a to the communication device 12a. Then, the optical communication system 1a controls the power of the power feeding light output from the optical power feeding light source of the communication device 11a on the basis of the measured optical loss value. At this time, the optical communication system 1a controls the intensity of the power of the power feeding light transmitted from the optical power feeding light source, so that the power of the power feeding light input to the photoelectric converter of the communication device on the power receiving side does not become equal to or greater than a predetermined value.

In addition, as described above, in the optical communication system 1a according to the second embodiment, the communication device 12a notifies the communication device 11a of the charge state of the secondary power supply 122a of the communication device 12a using reflected light of the power feeding light. Then, the optical communication system 1a performs control to switch on and off the output of the power feeding light transmitted from the optical power feeding light source according to the charge state of the secondary power supply 122a of the communication device 12a. Note, however, that as described above, when the output of the power feeding light is turned off, the reflected light also does not exist. Hence, from this point onward, the communication device 12a cannot notify the communication device 11a of the charge state of the secondary power supply 122a. Therefore, the optical communication system 1a according to the second embodiment transmits the overdischarge notification indicating that the remaining charge amount of the secondary power supply 122a is empty from the communication device 12a to the communication device 11a using communication light instead of using reflected light. As a result, the communication device 11a can recognize that the remaining charge amount of the secondary power supply 122a is empty even if reflected light is not received.

With such a characteristic, the optical communication system 1a according to the second embodiment can reduce the power consumption of the optical power feeding light source.

### Third Embodiment

Hereinafter, an optical communication system 1b according to a third embodiment of the present invention will be described. The optical communication system 1b is an example of an optical power feeding system of the present invention.

In the optical communication system 1 according to the first embodiment described above and the optical communication system 1a according to the second embodiment described above, the optical fiber through which power feeding light is transmitted is an optical fiber different from the optical fiber through which communication light is transmitted. On the other hand, the optical communication system 1b according to the third embodiment has a configuration in which transmission of power feeding light and transmission of communication light are performed using the same optical fiber cable. As the technology for performing transmission of power feeding light and transmission of communication light using the same optical fiber cable, for example, wavelength division multiplexing (WDM) can be used.

The configuration of the optical communication system 1b according to the third embodiment of the present invention is modified from the configuration of the optical communication system 1 according to the first embodiment described above such that transmission of power feeding light and transmission of communication light are performed using the same optical fiber cable.

### [Configuration of Optical Communication System]

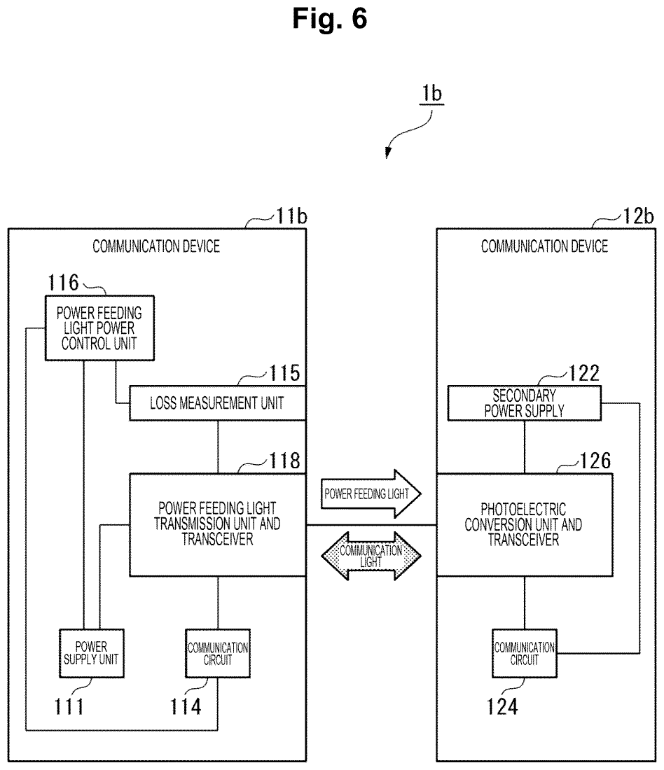

Hereinafter, the configuration of the optical communication system 1b will be described in more detail. FIG. 6 is a block diagram illustrating an overall configuration of the optical communication system 1b according to the third embodiment of the present invention. As illustrated in FIG. 6, the optical communication system 1b includes a communication device 11b and a communication device 12b. The communication device 11b and the communication device 12b are connected by wire, and transmit and receive data by transmitting and receiving communication light to and from each other. The communication device 11b and the communication device 12b are connected by an optical fiber cable for both communication and power supply, and communication light is transmitted via the optical fiber cable.

In addition, the power feeding light output from the communication device 11b is transmitted via the optical fiber cable used for both communication and power supply, and is input to the communication device 12b. That is, the communication device 11b is a communication device on the power feeding side on which an optical power feeding light source is mounted, and the communication device 12b is a communication device on the power receiving side on which a photoelectric converter is mounted.

Note that, in the following description, among functional units included in the optical communication system 1b according to the third embodiment, functional units having functions similar to those of the optical communication system 1 according to the first embodiment described above are denoted by the same reference numerals, and description thereof may be omitted.

As illustrated in FIG. 6, the communication device 11b includes a power supply unit 111, a communication circuit 114, a loss measurement unit 115, a power feeding light power control unit 116, and a power feeding light transmission unit and transceiver 118. The communication device 11b is, for example, an OLT. The communication device 11b is an example of the communication device of the present invention.

The power supply unit 111 is a light source power supply for generating the power feeding light transmitted from the power feeding light transmission unit and transceiver 118. The power feeding light transmission unit and transceiver 118 transmits power feeding light to the communication device 12b. The power feeding light transmission unit and transceiver 118 includes, for example, a laser diode. The power feeding light transmission unit and transceiver 118 transmits and receives communication light between the own device and the communication device 12b. The communication circuit 114 controls the power feeding light transmission unit and transceiver 118 to transmit and receive data between the own device and the communication device 12b using communication light.

The loss measurement unit 115 measures the optical loss value of the power feeding light transmitted from the communication device 11b to the communication device 12b. The loss measurement unit 115 outputs information indicating the measured optical loss value to the power feeding light power control unit 116. For example, the loss measurement unit 115 measures the optical loss value of the power feeding light when the communication device 11b and the communication device 12b are connected. Alternatively, for example, the loss measurement unit 115 measures the optical loss value of the power feeding light at predetermined intervals (for example, every hour or every day).

The power feeding light power control unit 116 acquires information indicating the optical loss value output from the loss measurement unit 115. The power feeding light power control unit 116 controls the power of the power feeding light transmitted from the power feeding light transmission unit and transceiver 118 by controlling the power supply unit 111 according to the acquired optical loss value. At this time, the power feeding light power control unit 116 curbs the power of the power feeding light to be transmitted from the power feeding light transmission unit and transceiver 118, so that the power of the power feeding light input to the communication device 12b on the power receiving side does not become equal to or greater than a predetermined value.

Furthermore, as illustrated in FIG. 6, the communication device 12b includes a secondary power supply 122, a communication circuit 124, and a photoelectric conversion unit and transceiver 126. The communication device 12b is, for example, an ONU.

The photoelectric conversion unit and transceiver 126 receives the power feeding light transmitted from the communication device 11b. The photoelectric conversion unit and transceiver 126 converts the received power feeding light into power. The photoelectric conversion unit and transceiver 126 includes, for example, a photodiode. The secondary power supply 122 stores the power converted by the photoelectric conversion unit and transceiver 126. Each functional unit of the communication device 12b is driven by power stored in the secondary power supply 122. The photoelectric conversion unit and transceiver 126 transmits and receives communication light between the own device and the communication device 11b. The communication circuit 124 controls the photoelectric conversion unit and transceiver 126 to transmit and receive data between the own device and the communication device 11b using communication light.

Further, the secondary power supply 122 periodically (for example, every minute or every hour) outputs information indicating its own charge state to the communication circuit 124. Note that the communication circuit 124 may be configured to be able to periodically detect the charge state of the secondary power supply 122.

When fully charged, the secondary power supply 122 outputs information indicating the fully charged state to the communication circuit 124. Then, the communication circuit 124 notifies the communication device 11b that the secondary power supply 122 is fully charged. Specifically, the communication circuit 124 transmits a full charge notification indicating that the secondary power supply 122 is fully charged to the communication device 11b via the photoelectric conversion unit and transceiver 126 by communication light.

The communication circuit 114 of the communication device 11b acquires the full charge notification transmitted from the communication device 12b on the power receiving side via the power feeding light transmission unit and transceiver 118. When acquiring the full charge notification, the communication circuit 114 outputs the full charge notification to the power feeding light power control unit 116. The power feeding light power control unit 116 acquires the full charge notification output from the communication circuit 114. When acquiring the full charge notification, the power feeding light power control unit 116 controls the power supply unit 111 to stop the transmission of the power feeding light to the communication device 12b by the power feeding light transmission unit and transceiver 118. As a result, power supply to the communication device 12b is stopped.

In addition, when the remaining charge amount is equal to or less than a predetermined value, the secondary power supply 122 outputs information indicating that the remaining charge amount is equal to or less than the predetermined value to the communication circuit 124. The communication circuit 124 notifies the communication device 11b that the remaining charge amount of the secondary power supply 122 is equal to or less than the predetermined value. Specifically, the communication circuit 124 transmits a remaining charge amount reduction notification indicating that the remaining charge amount of the secondary power supply 122 is equal to or less than a predetermined value to the communication device 11b via the photoelectric conversion unit and transceiver 126 by communication light.

The communication circuit 114 of the communication device 11b acquires the remaining charge amount reduction notification transmitted from the communication device 12b on the power receiving side via the power feeding light transmission unit and transceiver 118. When acquiring the remaining charge amount reduction notification, the communication circuit 114 outputs the remaining charge amount reduction notification to the power feeding light power control unit 116. The power feeding light power control unit 116 acquires the remaining charge amount reduction notification output from the communication circuit 114. When acquiring the remaining charge amount reduction notification, the power feeding light power control unit 116 controls the power supply unit 111 to resume the transmission of the power feeding light to the communication device 12b by the power feeding light transmission unit and transceiver 118. As a result, the power supply to the communication device 12b is resumed.

As described above, the configuration of the optical communication system 1b according to the third embodiment is modified from the configuration of the optical communication system 1 according to the first embodiment described above such that transmission of power feeding light and transmission of communication light are performed using the same optical fiber cable.

With such a configuration, the optical communication system 1b can reduce the number of required optical fiber cables, for example, and thus can reduce device cost, installation cost, installation space, operation cost, and the like.

### Fourth Embodiment

Hereinafter, an optical communication system 1c according to a fourth embodiment of the present invention will be described.

The configuration of the optical communication system 1c according to the fourth embodiment of the present invention is modified from the configuration of the optical communication system 1a according to the second embodiment described above such that transmission of power feeding light and transmission of communication light are performed using the same optical fiber cable. As the technology for performing transmission of power feeding light and transmission of communication light using the same optical fiber cable, for example, WDM can be used.

### [Configuration of Optical Communication System]

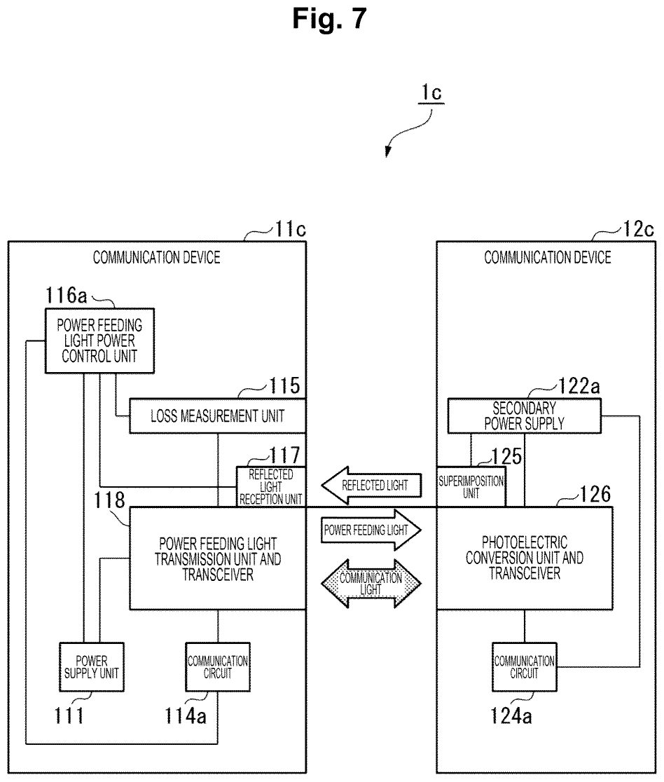

Hereinafter, the configuration of the optical communication system 1c will be described in more detail. FIG. 7 is a block diagram illustrating an overall configuration of the optical communication system 1c according to the fourth embodiment of the present invention. As illustrated in FIG. 7, the optical communication system 1c includes a communication device 11c and a communication device 12c. The communication device 11c and the communication device 12c are connected by wire, and transmit and receive data by transmitting and receiving communication light to and from each other. The communication device 11c and the communication device 12c are connected by an optical fiber cable for both communication and power supply, and communication light is transmitted via the optical fiber cable.

In addition, the power feeding light output from the communication device 11c is transmitted via the optical fiber cable used for both communication and power supply, and is input to the communication device 12c. That is, the communication device 11c is a communication device on the power feeding side on which an optical power feeding light source is mounted, and the communication device 12c is a communication device on the power receiving side on which a photoelectric converter is mounted.

Note that, in the following description, among functional units included in the optical communication system 1c according to the fourth embodiment, functional units having functions similar to those of the optical communication system 1a according to the second embodiment described above are denoted by the same reference numerals, and description thereof may be omitted.

As illustrated in FIG. 7, the communication device 11c includes a communication circuit 114a, a loss measurement unit 115, a power feeding light power control unit 116a, a reflected light reception unit 117, and a power feeding light transmission unit and transceiver 118. The communication device 11c is, for example, an OLT. The communication device 11c is an example of the communication device of the present invention.

The power supply unit 111 is a light source power supply for generating the power feeding light transmitted from the power feeding light transmission unit and transceiver 118. The power feeding light transmission unit and transceiver 118 transmits power feeding light to the communication device 12c. The power feeding light transmission unit and transceiver 118 is a transceiver that transmits and receives communication light between the own device and the communication device 12c. The communication circuit 114a controls the power feeding light transmission unit and transceiver 118 to transmit and receive data between the own device and the communication device 12c using communication light.

The loss measurement unit 115 measures the optical loss value of the power feeding light transmitted from the communication device 11c to the communication device 12c. The loss measurement unit 115 outputs information indicating the measured optical loss value to the power feeding light power control unit 116a. For example, the loss measurement unit 115 measures the optical loss value of the power feeding light when the communication device 11c and the communication device 12c are connected. Alternatively, for example, the loss measurement unit 115 measures the optical loss value of the power feeding light at predetermined intervals (for example, every hour or every day). Note that any existing technology can be used as a method of measuring the optical loss value of the power feeding light.

The power feeding light power control unit 116a acquires the information indicating the optical loss value output from the loss measurement unit 115. The power feeding light power control unit 116a controls the power of the power feeding light transmitted from the power feeding light transmission unit and transceiver 118 by controlling the power supply unit 111 according to the acquired optical loss value. The power feeding light power control unit 116a curbs the power of the power feeding light to be transmitted from the power feeding light transmission unit and transceiver 118, so that the power of the power feeding light input to the communication device 12c on the power receiving side does not become equal to or greater than a predetermined value.

The reflected light reception unit 117 receives the reflected light of the power feeding light transmitted from the power feeding light transmission unit and transceiver 118. As described above, the reflected light is the reflected light with respect to the power feeding light transmitted from the power feeding light transmission unit and transceiver 118 to the communication device 12c. A notification regarding the charge state of the secondary power supply 122a of the communication device 12c is superimposed on the reflected light. The reflected light reception unit 117 demodulates the reflected light and acquires a notification regarding the charge state of a secondary power supply 122a. The reflected light reception unit 117 includes, for example, a demodulator, and is provided side by side with the power feeding light transmission unit and transceiver 118. The reflected light reception unit 117 outputs the acquired notification regarding the charge state of the secondary power supply 122a to the power feeding light power control unit 116a.

As a type of notification regarding the charge state of the secondary power supply 122a superimposed on the reflected light, for example, there is a full charge notification. Note that the full charge notification does not necessarily need to be information indicating that the secondary power supply 122a is actually fully charged, and may be, for example, information indicating that the secondary power supply 122a is in a state where the remaining charge amount is equal to or greater than a predetermined value (that is, information indicating that a sufficient remaining charge amount has been reached). Note that, as a type of notification regarding the charge state of the secondary power supply 122a superimposed on the reflected light, for example, there may be a remaining charge amount reduction notification.

The power feeding light power control unit 116a acquires the notification regarding the charge state of the secondary power supply 122a output from the reflected light reception unit 117. The power feeding light power control unit 116a controls the power of the power feeding light transmitted from the power feeding light transmission unit and transceiver 118 by controlling the power supply unit 111 according to the acquired notification regarding the charge state of the secondary power supply 122a.

The power feeding light power control unit 116a acquires the full charge notification output from the reflected light reception unit 117. When acquiring the full charge notification, the power feeding light power control unit 116a controls the power supply unit 111 to stop the transmission of the power feeding light to the communication device 12c by the power feeding light transmission unit and transceiver 118. As a result, power supply to the communication device 12c is stopped.

Note that the power feeding light power control unit 116a may acquire the remaining charge amount reduction notification output from the reflected light reception unit 117. Then, when acquiring the remaining charge amount reduction notification, the power feeding light power control unit 116 may control the power supply unit 111 to make the power of the power feeding light transmitted to the communication device 12c by the power feeding light transmission unit and transceiver 118 stronger. As a result, more appropriate power supply to the communication device 12c is performed.

Furthermore, as illustrated in FIG. 7, the communication device 12c includes a secondary power supply 122a, a communication circuit 124a, a superimposition unit 125, and a photoelectric conversion unit and transceiver 126. The communication device 12c is, for example, an ONU.

The photoelectric conversion unit 121 receives power feeding light transmitted from the communication device 11c. The photoelectric conversion unit and transceiver 126 converts the received power feeding light into power. The secondary power supply 122a stores the power converted by the photoelectric conversion unit and transceiver 126. In addition, the photoelectric conversion unit and transceiver 126 transmits and receives communication light between the own device and the communication device 11c. The communication circuit 124 controls the photoelectric conversion unit and transceiver 126, and transmits and receives data between the own device and the communication device 11c using communication light.

In addition, the secondary power supply 122a outputs information indicating its own charge state to the superimposition unit 125 periodically (for example, every minute or every hour). Note that the superimposition unit 125 may be configured to be able to periodically detect the charge state of the secondary power supply 122a.

The superimposition unit 125 acquires information indicating the charge state of the secondary power supply 122a from the secondary power supply 122a. The superimposition unit 125 superimposes a part of the power feeding light received by the photoelectric conversion unit 121 on the reflected light of the power feeding light by modulating the notification regarding the charge state of the secondary power supply 122a. The superimposition unit 125 includes, for example, a reflective modulator, and is provided side by side with the photoelectric conversion unit and transceiver 126. The superimposition unit 125 transmits the reflected light on which the notification regarding the charge state of the secondary power supply 122a is superimposed to the communication device 11c.

For example, when fully charged, the secondary power supply 122a outputs information indicating the fully charged state to the superimposition unit 125. Then, the superimposition unit 125 superimposes the full charge notification indicating that the secondary power supply 122a is fully charged on the reflected light of the power feeding light by modulating the full charge notification. The superimposition unit 125 transmits the reflected light on which the full charge notification of the secondary power supply 122a is superimposed to the communication device 11c.

In addition, when the remaining charge amount is empty (0), the secondary power supply 122a outputs information indicating that the remaining charge amount is empty to the communication circuit 124a. Note that the communication circuit 124a may be configured to be able to detect that the remaining charge amount of the secondary power supply 122a is empty.

The communication circuit 124a notifies the communication device 11c that the remaining charge amount of the secondary power supply 122a is empty. Specifically, the communication circuit 124 transmits an overdischarge notification indicating that the remaining charge amount of the secondary power supply 122a is empty to the communication device 11c via the photoelectric conversion unit and transceiver 126 by communication light.

Note that the overdischarge notification does not necessarily need to be information indicating that the secondary power supply 122a is actually empty, and may be information indicating that the secondary power supply 122a is in a state where the remaining charge amount is equal to or less than a predetermined value (that is, information indicating that the remaining charge amount has become insufficient).

The communication circuit 114a of the communication device 11c on the power feeding side acquires the overdischarge notification transmitted from the communication device 12c on the power receiving side via the power feeding light transmission unit and transceiver 118. The communication circuit 114a outputs the overdischarge notification to the power feeding light power control unit 116a. When acquiring the overdischarge notification, the power feeding light power control unit 116a controls the power supply unit 111 to resume the transmission of the power feeding light to the communication device 12c by the power feeding light transmission unit and transceiver 118. As a result, the power supply to the communication device 12c is resumed.

Note that the case where the remaining charge amount of the secondary power supply 122a of the communication device 12c is empty is assumed to be a case where power is not supplied from the communication device 11c to the communication device 12c. In a case where the power feeding light is not transmitted from the communication device 11c to the communication device 12c, since there is no reflected light of the power feeding light, the overdischarge notification cannot be superimposed on the reflected light and transmitted from the communication device 12c to the communication device 11c. Therefore, the overdischarge notification is transmitted from the communication device 12c to the communication device 11c using communication light.

As described above, the configuration of the optical communication system 1c according to the fourth embodiment is modified from the configuration of the optical communication system 1a according to the second embodiment described above such that transmission of power feeding light and transmission of communication light are performed using the same optical fiber cable.

With such a configuration, the optical communication system 1c can reduce the number of required optical fiber cables, for example, and thus can reduce device cost, installation cost, installation space, operation cost, and the like.

### Fifth Embodiment

Hereinafter, an optical communication system 1d according to a fifth embodiment of the present invention will be described. The optical communication system 1d is an example of an optical power feeding system of the present invention.

In the above-described first to fourth embodiments, basically, the network configuration of the optical communication systems 1 and 1a to 1c is assumed to be a single-star configuration in which the communication device on the power feeding side (communication devices 11 and 11a to 11c) and the communication device on the power receiving side (communication devices 12 and 12a to 12c) are connected on a one-to-one basis. With the one-to-one configuration, for example, it is possible to prevent an optical loss caused by branching of the optical fiber, and thus, it is possible to achieve efficient optical power feeding. On the other hand, the optical communication system 1d according to the fifth embodiment described below is assumed to have a double star configuration in which a communication device on the power feeding side (communication device 11d) and communication devices on the power receiving side (communication devices 12-1 to 12-n) are connected in a one-to-many manner. With the one-to-many configuration, for example, the number of communication devices (communication devices 11d), optical fibers, and the like on the power feeding side can be reduced, so that device cost, installation cost, operation cost, and the like can be reduced.

The optical communication system 1d according to the fifth embodiment is a system in which a communication device on a power feeding side on which an optical power feeding light source is mounted and a plurality of communication devices on a power receiving side on which photoelectric converters are mounted are connected to each other by wire via a branching unit such as an optical splitter to perform optical power feeding and communication. The optical communication system 1d measures each optical loss value of the power feeding light transmitted from the communication device on the power feeding side to the plurality of communication devices on the power receiving side.

Then, the optical communication system 1d is characterized by controlling the power of the power feeding light output from the optical power feeding light source of the communication device on the power feeding side on the basis of the measured optical loss value. At this time, for example, in a case where at least one of the plurality of measured optical loss values is equal to or greater than a predetermined value, the optical communication system 1d performs control to maximize the output of the power feeding light. Furthermore, for example, in a case where all of the plurality of measured optical loss values are less than the predetermined value, the optical communication system 1d controls the output of the power feeding light so as to obtain an output value obtained by adding the maximum value of the plurality of measured optical loss values to the preset output value.

In addition, the optical communication system 1d performs control to switch on and off the output of the power feeding light transmitted from the optical power feeding light source according to the charge state of the secondary power supply of the communication device on the power receiving side. For example, the optical communication system 1d performs control to turn on the output of the power feeding light when the charge state of the secondary power supply of at least one communication device on the power receiving side is not a fully charged state, and performs control to turn off the output of the power feeding light when the charge states of the secondary power supplies of all the communication devices on the power receiving side are fully charged states. With such a characteristic, the optical communication system 1d according to the fifth embodiment can reduce the power consumption of the optical power feeding light source even in a network configuration in which the communication device on the power feeding side and the communication device on the power receiving side are connected to each other in a one-to-many manner as in a double star configuration, for example.

### [Configuration of Optical Communication System]

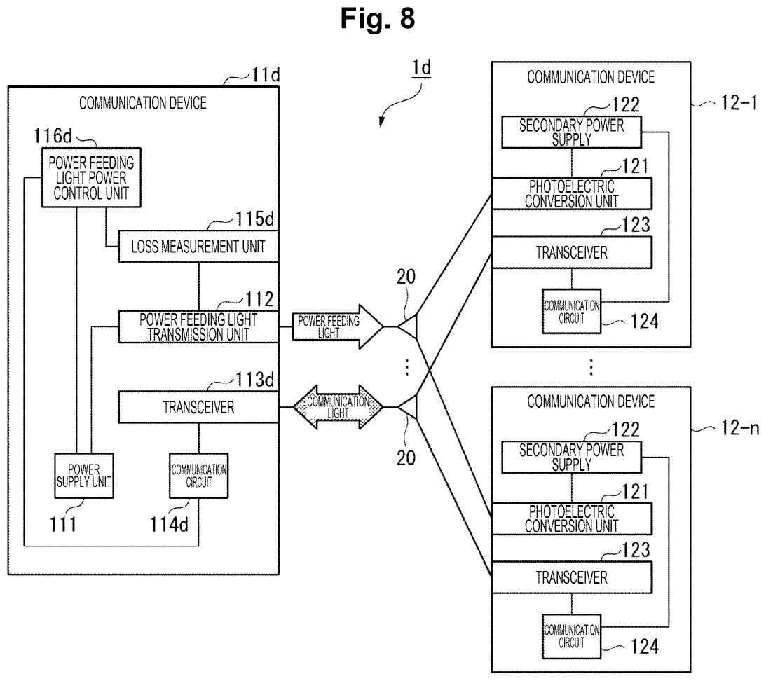

Hereinafter, the configuration of the optical communication system 1d will be described in more detail. FIG. 8 is a block diagram illustrating an overall configuration of the optical communication system 1d according to the fifth embodiment of the present invention. As illustrated in FIG. 8, the optical communication system 1d includes a communication device 11d and a plurality of communication devices 12 (communication devices 12-1 to 12-n). The communication device 11d and each of the communication devices 12-1 to 12-n are connected by wire, and transmit and receive data by transmitting and receiving communication light to and from each other. For example, as illustrated in FIG. 8, the communication device 11d and each of the communication devices 12-1 to 12-n are connected by an optical fiber cable for communication branched one-to-many by a branching unit such as an optical splitter 20, and communication light is transmitted via the optical fiber cable for communication.

Note that the communication cable may be a cable other than the optical fiber cable. Furthermore, the communication device 11d and each of the communication devices 12-1 to 12-n may be wirelessly communicably connected.

Furthermore, the communication device 11d and each of the communication devices 12-1 to 12-n are connected by wire, and the power feeding light output from the communication device 11d is input to each of the communication devices 12-1 to 12-n. That is, the communication device 11d is a communication device on the power feeding side on which an optical power feeding light source is mounted, and each of the communication devices 12-1 to 12-n is a communication device on the power receiving side on which a photoelectric converter is mounted. The communication device 11d and each of the communication devices 12-1 to 12-n are connected to each other by a power supply optical fiber cable different from the above-described optical fiber cable for communication and is branched one-to-many by a branching unit such as the optical splitter 20 as illustrated in FIG. 8, and power feeding light is transmitted via the power supply optical fiber cable.

As illustrated in FIG. 8, the communication device 11d includes a power supply unit 111, a power feeding light transmission unit 112, a transceiver 113d, a communication circuit 114d, a loss measurement unit 115d, and a power feeding light power control unit 116d. The communication device 11d is, for example, an optical line termination device (OLT) installed on a station side of a communication company in a PON type subscriber line network (public line network) using an optical fiber. The communication device 11d is an example of the communication device of the present invention.

The power supply unit 111 is a light source power supply for generating the power feeding light transmitted from the power feeding light transmission unit 112. The power feeding light transmission unit 112 transmits power feeding light to the plurality of communication devices 12 (communication devices 12-1 to 12-n). The power feeding light transmission unit 112 is, for example, a laser diode. The transceiver 113d is a transceiver that transmits and receives communication light between the own device and each of the plurality of communication devices 12 (communication devices 12-1 to 12-n). The communication circuit 114d controls the transceiver 113d to transmit and receive data between the own device and each of the plurality of communication devices 12 (communication devices 12-1 to 12-n) using communication light.

The loss measurement unit 115d measures the optical loss value of the power feeding light transmitted from the communication device 11d to each of the plurality of communication devices 12 (communication devices 12-1 to 12-n). The loss measurement unit 115d outputs information indicating the plurality of measured optical loss values to the power feeding light power control unit 116d. For example, when the communication device 11d is connected to a new communication device 12, the loss measurement unit 115d measures the optical loss value of the power feeding light transmitted from the communication device 11d to each of the plurality of communication devices 12 (communication devices 12-1 to 12-n). Alternatively, for example, the loss measurement unit 115d measures the optical loss value of the power feeding light transmitted from the communication device 11d to each of the plurality of communication devices 12 (communication devices 12-1 to 12-n) at predetermined intervals (for example, every hour or every day).

Note that any existing technology can be used as a method of measuring the optical loss value of the power feeding light. For example, the loss measurement unit 115d measures the optical loss value using an optical time domain reflectometer (OTDR). As a method for measuring the optical loss value using the OTDR, for example, a technology described in Non Patent Literature 2 can be used.

For example, the loss measurement unit 115d measures the distance from the communication device 11d on the power feeding side to each of the communication devices 12 (communication devices 12-1 to 12-n) on the power receiving side by the OTDR. Then, the loss measurement unit 115d calculates each optical loss value by multiplying each measured distance by the optical loss per unit. Alternatively, for example, the loss measurement unit 115d directly measures the optical loss value of the power feeding light between the communication device 11d and each of the communication devices 12 (communication devices 12-1 to 12-n) by the OTDR.

The power feeding light power control unit 116d acquires the information indicating the plurality of optical loss values output from the loss measurement unit 115d. The power feeding light power control unit 116d controls the power of the power feeding light transmitted from the power feeding light transmission unit 112 by controlling the power supply unit 111 according to the plurality of acquired optical loss values.

At this time, in a case where at least one of the plurality of acquired optical loss values is equal to or greater than a predetermined value, the power feeding light power control unit 116d controls the power supply unit 111 to maximize the output of the power feeding light transmitted from the power feeding light transmission unit 112. The predetermined value here is, for example, a value having a maximum width with which the power feeding light transmission unit 112 can further increase the output of the power feeding light.

Furthermore, in a case where all of the plurality of acquired optical loss values are less than the predetermined value, the power feeding light power control unit 116d controls the power supply unit 111 so that the power feeding light is transmitted from the power feeding light transmission unit 112 with an output value obtained by adding the maximum value of the plurality of acquired optical loss values to the preset output value.

Note that the value of the power of the power feeding light transmitted from the power feeding light transmission unit 112 is predetermined for each optical loss value. For example, a table in which the optical loss value and the power value of the power feeding light are associated with each other is stored in advance in a storage medium (not illustrated) provided in the communication device 11d. The power feeding light power control unit 116d refers to the table and acquires the power value of the power feeding light corresponding to the acquired optical loss value. Then, the power feeding light power control unit 116d controls the power supply unit 111 so that the power of the power feeding light transmitted from the power feeding light transmission unit 112 has the acquired value.

Furthermore, as illustrated in FIG. 8, each of the communication devices 12-1 to 12-n includes a photoelectric conversion unit 121, a secondary power supply 122, a transceiver 123, and a communication circuit 124. Each of the communication devices 12-1 to 12-n is, for example, a terminal device (ONU) of an optical line installed in a subscriber's home in a PON type subscriber line network (public line network) using an optical fiber.

The photoelectric conversion unit 121 receives the power feeding light transmitted from the communication device 11d and transmitted via the optical splitter 20. The photoelectric conversion unit 121 converts the received power feeding light into power. The photoelectric conversion unit 121 is, for example, a photodiode. The secondary power supply 122 stores the power converted by the photoelectric conversion unit 121. Each functional unit of each of the communication devices 12-1 to 12-n is driven by power stored in the secondary power supply 122. The secondary power supply 122 includes, for example, a battery. The transceiver 123 is a transceiver that transmits and receives communication light between the own device and the communication device 11d. The communication circuit 124 controls the transceiver 123 to transmit and receive data between the own device and the communication device 11d using communication light.

Further, the secondary power supply 122 periodically (for example, every minute or every hour) outputs information indicating its own charge state to the communication circuit 124. Note that the communication circuit 124 may be configured to be able to periodically detect the charge state of the secondary power supply 122.

When fully charged, the secondary power supply 122 outputs information indicating the fully charged state to the communication circuit 124. Then, the communication circuit 124 notifies the communication device 11d that the secondary power supply 122 is fully charged. Specifically, the communication circuit 124 transmits a full charge notification, which is information indicating that the secondary power supply 122 is fully charged, to the communication device 11d via the transceiver 123 by communication light.

The communication circuit 114d of the communication device 11d acquires the full charge notification transmitted from each of the communication devices 12 (communication devices 12-1 to 12-n) on the power receiving side via the transceiver 113d. When acquiring the full charge notification, the communication circuit 114d outputs the full charge notification to the power feeding light power control unit 116d. The power feeding light power control unit 116d acquires the full charge notification output from the communication circuit 114d.

In addition, the power feeding light power control unit 116d performs control to switch on and off the output of the power feeding light transmitted from the power feeding light transmission unit 112 according to the charge state of the secondary power supply of each of the communication devices 12 (communication devices 12-1 to 12-n) on the power receiving side.

For example, when the charge state of the secondary power supply of at least one communication device 12 (any one of the communication devices 12-1 to 12-n) on the power receiving side is not a fully charged state (that is, when the full charge notification is not acquired from at least one communication device 12 on the power receiving side), the power feeding light power control unit 116d controls the power supply unit 111 to start, resume, or continue the transmission of the power feeding light from the power feeding light transmission unit 112. In addition, for example, when the charge state of the secondary power supplies of all the communication devices 12 (the communication devices 12-1 to 12-n) on the power receiving side is a fully charged state (that is, when full charge notifications are acquired from all the communication devices 12 on the power receiving side), the power feeding light power control unit 116d controls the power supply unit 111 so as to stop the transmission of the power feeding light from the power feeding light transmission unit 112. As a result, power supply to each of the communication devices 12 (communication devices 12-1 to 12-n) is stopped.

In addition, when the remaining charge amount is equal to or less than a predetermined value, the secondary power supply 122 outputs information indicating that the remaining charge amount is equal to or less than the predetermined value to the communication circuit 124. The communication circuit 124 notifies the communication device 11d that the remaining charge amount of the secondary power supply 122 is equal to or less than the predetermined value. Specifically, the communication circuit 124 transmits a remaining charge amount reduction notification, which is information indicating that the remaining charge amount of the secondary power supply 122 is equal to or less than a predetermined value, to the communication device 11d via the transceiver 123 by communication light.

The communication circuit 114d of the communication device 11d acquires the remaining charge amount reduction notification transmitted from each of the communication devices 12 (communication devices 12-1 to 12-n) on the power receiving side via the transceiver 113d. When acquiring the remaining charge amount reduction notification, the communication circuit 114d outputs the remaining charge amount reduction notification to the power feeding light power control unit 116d. The power feeding light power control unit 116d acquires the remaining charge amount reduction notification output from the communication circuit 114d.

When acquiring the remaining charge amount reduction notification from at least one communication device 12 on the power receiving side, the power feeding light power control unit 116d controls the power supply unit 111 to resume the transmission of the power feeding light to each of the communication devices 12 (communication devices 12-1 to 12-n) by the power feeding light transmission unit 112. As a result, power supply to each of the communication devices 12 (communication devices 12-1 to 12-n) is resumed.

### [Operation of Optical Communication System]

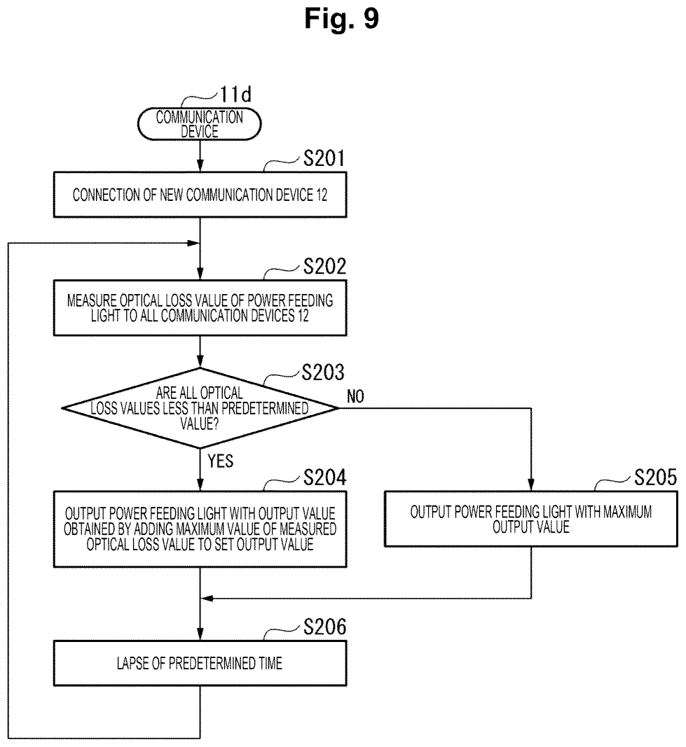

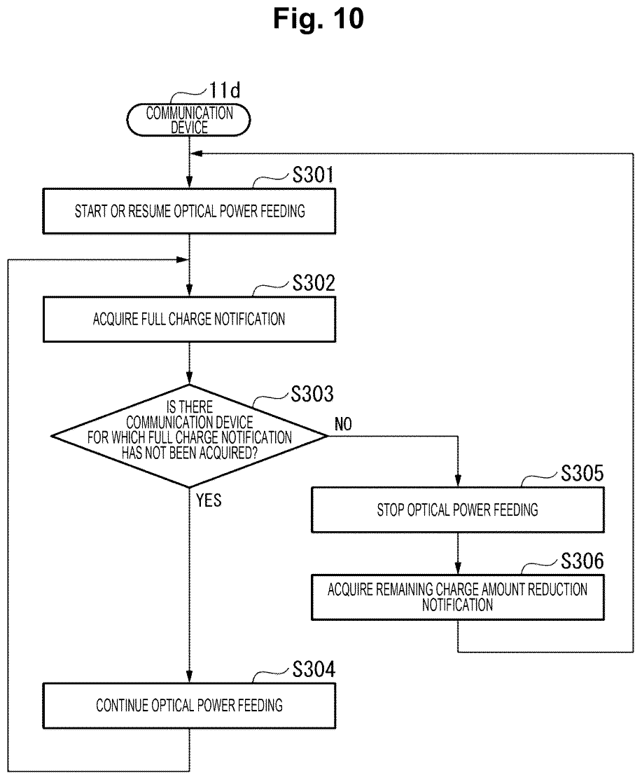

Hereinafter, an example of the operation of the communication device 11d will be described. FIGS. 9 and 10 are flowcharts illustrating the operation of the communication device 11d according to the fifth embodiment of the present invention.

The flowchart of FIG. 9 illustrates processing of output control of the power feeding light based on the measured value of the optical loss value. The operation of the communication device 11d illustrated in the flowchart of FIG. 9 is started, for example, when a communication device 12 on the power receiving side is newly connected to the communication device 11d on the power feeding side (step S201). The loss measurement unit 115d measures the optical loss value of the power feeding light transmitted from the communication device 11d to each of the communication devices 12 (communication devices 12-1 to 12-n) (step S202).

The loss measurement unit 115d outputs information indicating the plurality of measured optical loss values to the power feeding light power control unit 116d. The power feeding light power control unit 116d controls the power supply unit 111 according to the plurality of acquired optical loss values. The power feeding light power control unit 116d determines whether or not all the acquired optical loss values are less than a predetermined value (step S203).

If it is determined that all the optical loss values are less than the predetermined value (step S203: YES), the power feeding light power control unit 116d controls the power supply unit 111 so that the power feeding light is transmitted from the power feeding light transmission unit 112 with an output value obtained by adding the maximum values of the plurality of measured optical loss values to the preset output value (step S204).

On the other hand, if it is determined that at least one optical loss value is equal to or greater than the predetermined value (step S203: NO), the power supply unit 111 is controlled so that the power feeding light is output from the power feeding light transmission unit 112 with the maximum output value (step S205).

The communication device 11d stands by until a predetermined time elapses, and then repeats the above processing of step S202 and subsequent steps.

The flowchart of FIG. 10 illustrates processing of output control of the power feeding light based on the power storage state of the secondary power supply 122 of each of the communication devices 12 (communication devices 12-1 to 12-n). The operation of the communication device 11d illustrated in the flowchart of FIG. 10 is started, for example, when optical power feeding is started or resumed (step S301).

The communication circuit 114d acquires a full charge notification transmitted from any one of the plurality of communication devices 12 (communication devices 12-1 to 12-n) on the power receiving side via the transceiver 113d (step S302). When acquiring the full charge notification, the communication circuit 114d outputs the full charge notification to the power feeding light power control unit 116d. The power feeding light power control unit 116d acquires the full charge notification output from the communication circuit 114d.

The power feeding light power control unit 116d determines whether or not there is a communication device 12 for which a full charge notification has not been acquired among the plurality of communication devices 12 (communication devices 12-1 to 12-n) on the power receiving side (step S303). If it is determined that there is a communication device 12 for which a full charge notification has not been acquired (step S303: YES), the power feeding light power control unit 116d performs control to continue transmission of the power feeding light from the power feeding light transmission unit 112 (step S304). Then, the communication device 11d repeats the above processing of step S302 and subsequent steps.

On the other hand, if it is determined that there is no communication device 12 for which a full charge notification has not been acquired (step S303: NO), the power feeding light power control unit 116d controls the power supply unit 111 to stop the transmission of the power feeding light from the power feeding light transmission unit 112 (step S305).

Thereafter, the communication circuit 114d acquires a remaining charge amount reduction notification transmitted from any of the plurality of communication devices 12 (communication devices 12-1 to 12-n) on the power receiving side via the transceiver 113d (step S306). When acquiring the remaining charge amount reduction notification, the communication circuit 114d outputs the remaining charge amount reduction notification to the power feeding light power control unit 116d. The power feeding light power control unit 116d acquires the remaining charge amount reduction notification output from the communication circuit 114d.

When acquiring the remaining charge amount reduction notification, the power feeding light power control unit 116d controls the power supply unit 111 to resume the transmission of the power feeding light to each of the communication devices 12 (communication devices 12-1 to 12-n) by the power feeding light transmission unit 112 (step S301). Then, the communication device 11d repeats the above processing of step S302 and subsequent steps.

As described above, in the optical communication system 1d according to the fifth embodiment, the communication device 11d on the power feeding side on which the optical power feeding light source is mounted and each of the plurality of communication devices 12 (communication devices 12-1 to 12-n) on the power receiving side on which the photoelectric converter is mounted are connected to each other by wire to perform optical power feeding and communication. The optical communication system 1d measures the optical loss value of the power feeding light transmitted from the communication device 11d to each of the communication devices 12 (communication devices 12-1 to 12-n). Then, the optical communication system 1d controls the power of the power feeding light output from the optical power feeding light source of the communication device 11d on the basis of the measured optical loss value.

At this time, for example, in a case where at least one of the plurality of measured optical loss values is equal to or greater than a predetermined value, the optical communication system 1d performs control to maximize the output of the power feeding light. Furthermore, for example, in a case where all of the plurality of measured optical loss values are less than the predetermined value, the optical communication system 1d controls the output of the power feeding light so as to obtain an output value obtained by adding the maximum value of the plurality of measured optical loss values to the preset output value.

In addition, the optical communication system 1d performs control to switch on and off the output of the power feeding light transmitted from the optical power feeding light source according to the charge state of the secondary power supply of the communication device on the power receiving side. For example, the optical communication system 1d performs control to turn on the output of the power feeding light when the charge state of the secondary power supply of at least one communication device on the power receiving side is not a fully charged state, and performs control to turn off the output of the power feeding light when the charge states of the secondary power supplies of all the communication devices on the power receiving side are fully charged states.

With such a characteristic, in various network configurations such as a network configuration in which communication devices are connected to each other in a one-to-many manner as in a double star configuration, for example, the optical communication system 1d according to the fifth embodiment can adjust the power of the power feeding light output from the optical power feeding light source such that the power of the power feeding light input to the photoelectric converter is not excessive on the basis of the optical loss value according to the installation location of each of the plurality of communication devices 12 (communication devices 12-1 to 12-n) on the power receiving side on which the photoelectric converter is mounted. As a result, the optical communication system 1d can reduce the power consumption of the optical power feeding light source.

In addition, with such a characteristic, the optical communication system 1d according to the fifth embodiment can stop the optical power feeding in a case where the secondary power supply of each of the communication devices 12 (communication devices 12-1 to 12-n) on the power receiving side on which the photoelectric converter is mounted is in a fully charged state. As a result, the optical communication system 1d can reduce the power consumption of the optical power feeding light source.

Note that the optical communication system 1d according to the fifth embodiment has a configuration in which, based on the configuration of the optical communication system 1 according to the first embodiment described above, control processing of an appropriate power feeding light output in a case where the communication device on the power feeding side and the communication device on the power receiving side are connected one-to-many is further added. That is, the optical communication system 1d according to the fifth embodiment is configured to notify the communication device on the power feeding side of the charge state of the secondary power supply from the communication device on the power receiving side using communication light, and the optical fiber for transmitting power feeding light and the optical fiber for transmitting communication light are separate optical fibers. Note, however, that the present invention is not limited to such a configuration, and the optical communication system according to the present invention may have a configuration in which, based on the configuration of any of the optical communication system 1a according to the second embodiment, the optical communication system 1b according to the third embodiment, or the optical communication system 1c according to the fourth embodiment described above, control processing of an appropriate power feeding light output in a case where the communication device on the power feeding side and the communication device on the power receiving side are connected one-to-many is further added. That is, the optical communication system according to the present invention may be configured to notify the communication device on the power feeding side of the charge state of the secondary power supply from the communication device on the power receiving side using reflected light of power feeding light, or may be configured such that the optical fiber for transmitting power feeding light and the optical fiber for transmitting communication light are the same optical fiber.

According to the above-described embodiment, the communication device includes a power feeding light transmission unit, a measurement unit, and a control unit. For example, the communication device is the communication device 11 of the embodiment, the power feeding light transmission unit is the power feeding light transmission unit 112 of the embodiment, the measurement unit is the loss measurement unit 115 of the embodiment, and the control unit is the power feeding light power control unit 116 of the embodiment. The power feeding light transmission unit transmits power feeding light to the opposing communication device. For example, the opposing communication device is the communication device 12 of the embodiment. The measurement unit measures an optical loss value in transmission of the power feeding light from the own device to the opposing communication device. The control unit controls the output of the power feeding light transmitted from the power feeding light transmission unit according to the optical loss value measured by the measurement unit.

Note that in the communication device, the measurement unit may measure the optical loss value using an optical pulse tester. In this case, the control unit may perform control such that the larger the optical loss value, the larger the output of the power feeding light.

Note that in the communication device, the power feeding light transmitted from the power feeding light transmission unit may be transmitted to a plurality of opposing communication devices via a branching unit. In this case, the measurement unit may measure each optical loss value in transmission of the power feeding light from the own device to the plurality of opposing communication devices. In this case, the control unit may control the output of the power feeding light according to the plurality of optical loss values measured by the measurement unit. For example, the communication device is the communication device 11d of the embodiment, the branching unit is the optical splitter 20 of the embodiment, the plurality of opposing communication devices are the communication devices 12-1 to 12-n of the embodiment, the measurement unit is the loss measurement unit 115d of the embodiment, and the control unit is the power feeding light power control unit 116d of the embodiment.

Note that in the communication device, in a case where at least one of the plurality of optical loss values measured by the measurement unit is equal to or greater than a predetermined value, the control unit may perform control to maximize the output of the power feeding light. In addition, in a case where all of the plurality of optical loss values measured by the measurement unit are less than the predetermined value, the control unit may control the output of the power feeding light so as to obtain an output value obtained by adding the maximum value of the plurality of optical loss values to a preset output value.

In addition, according to the above-described embodiment, the optical power feeding system includes the first communication device and the second communication device. For example, the optical power feeding system is the optical communication system 1 of the embodiment, the first communication device is the communication device 11 of the embodiment, and the second communication device is the communication device 12 of the embodiment. The first communication device includes a power feeding light transmission unit, a measurement unit, and a control unit. For example, the power feeding light transmission unit is the power feeding light transmission unit 112 of the embodiment, the measurement unit is the loss measurement unit 115 of the embodiment, and the control unit is the power feeding light power control unit 116 of the embodiment. The power feeding light transmission unit transmits power feeding light to the second communication device. The measurement unit measures an optical loss value in transmission of the power feeding light from the first communication device to the second communication device. The control unit controls the output of the power feeding light transmitted from the power feeding light transmission unit according to the optical loss value measured by the measurement unit. The second communication device includes a power feeding light reception unit, a photoelectric conversion unit, and a power storage unit. For example, the power feeding light reception unit and the photoelectric conversion unit are the photoelectric conversion unit 121 of the embodiment, and the power storage unit is the secondary power supply 122 of the embodiment. The power feeding light reception unit receives the power feeding light transmitted from the first communication device. The photoelectric conversion unit converts the power feeding light received by the power feeding light reception unit into power. The power storage unit stores the power converted by the photoelectric conversion unit.

Note that in the optical power feeding system, the second communication device may further include a power storage state information transmission unit. For example, the power storage state information transmission unit is the communication circuit 124 and the transceiver 123 of the embodiment. The power storage state information transmission unit may transmit first power storage state information indicating the power storage state of the power storage unit to the first communication device. In this case, the first communication device may further include a power storage state information acquisition unit. For example, the power storage state information acquisition unit is the communication circuit 114 and the transceiver 113 of the embodiment. The power storage state information acquisition unit may acquire the first power storage state information transmitted from the power storage state information transmission unit. In this case, the control unit may control output of the power feeding light transmitted from the power feeding light transmission unit according to the first power storage state information acquired by the power storage state information acquisition unit.

Note that in the optical power feeding system, the power storage state information transmission unit may transmit the first power storage state information superimposed on reflected light of power feeding light. For example, the optical power feeding system is the optical communication system 1a of the embodiment, and the power storage state information transmission unit is the superimposition unit 125 of the embodiment.

Note that in the optical power feeding system, the second communication device may further include a communication light transmission unit. For example, the optical power feeding system is the optical communication system 1a of the embodiment, and the communication light transmission unit is the communication circuit 124 and the transceiver 123 of the embodiment. The communication light transmission unit may transmit second power storage state information to the first communication device by communication light. In this case, the first communication device may further include a communication light reception unit. For example, the communication light reception unit is the transceiver 113 and the communication circuit 114 of the embodiment. The communication light reception unit may receive the second power storage state information transmitted from the second communication device. In a case where the power feeding light reception unit receives the power feeding light, the power storage state information transmission unit may transmit the first power storage state information to the first communication device. In a case where the power feeding light reception unit does not receive the power feeding light, the communication light transmission unit may transmit the second power storage state information to the first communication device. In this case, the control unit may control the output of the power feeding light according to the power storage state information acquired by the power storage state information acquisition unit or the communication light reception unit.

Note that in the optical power feeding system, the power feeding light transmitted from the power feeding light transmission unit may be transmitted to each of the plurality of second communication devices via the branching unit. In this case, the measurement unit may measure each optical loss value in transmission of the power feeding light from the first communication device to the plurality of second communication devices. In this case, the control unit may control the output of the power feeding light according to the plurality of optical loss values measured by the measurement unit. For example, the optical power feeding system is the optical communication system 1d of the embodiment, the first communication device is the communication device 11d of the embodiment, the branching unit is the optical splitter 20 of the embodiment, the plurality of second communication devices are the communication devices 12-1 to 12-n of the embodiment, the measurement unit is the loss measurement unit 115d of the embodiment, and the control unit is the power feeding light power control unit 116d of the embodiment.

Note that in the optical power feeding system, the control unit may perform control so as to maximize the output of the power feeding light in a case where the maximum value of the plurality of optical loss values measured by the measurement unit is equal to or greater than a predetermined value. In addition, the control unit may perform control to set the output of the power feeding light to a value obtained by adding the maximum value to a predetermined output value in a case where the maximum value is less than the predetermined value.

The communication devices 11 and 11a to 11c and the communication devices 12 and 12a to 12c in the above-described embodiments may be implemented by a computer. In that case, a program for implementing the functions may be recorded in a computer-readable recording medium, and the functions may be implemented by loading the program recorded in this recording medium to a computer system, and executing the program. Note that the “computer system” herein includes an OS and hardware such as peripheral devices. In addition, the “computer-readable recording medium” refers to a portable medium such as a flexible disk, a magneto-optical disc, a ROM, or a CD-ROM or a storage device such as a hard disk included in the computer system.

Furthermore, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. Also, the foregoing program may be for implementing some of the functions described above, may be implemented in a combination of the functions described above and a program already recorded in a computer system, or may be implemented with a programmable logic device such as a field programmable gate array (FPGA).

Although the embodiments of the present invention have been described in detail with reference to the drawings, the specific configuration is not limited to the embodiment, and includes design and the like within a range not departing from the gist of the present invention.

### REFERENCE SIGNS LIST

1, 1a, 1b, 1c, 1d, 8 Optical communication system
11, 11a, 11b, 11c, 11d, 12, 12a, 12b, 12c, 12-1 to 12-n, 81, 82 Communication device
111 Power supply unit
112 Power feeding light transmission unit
113 Transceiver
114, 114a Communication circuit
115, 115d Loss measurement unit
116, 116a, 116d Power feeding light power control unit
117 Reflected light reception unit
118 Power feeding light transmission unit and transceiver
121 Photoelectric conversion unit
122, 122a Secondary power supply
123 Transceiver
124, 124a Communication circuit
125 Superimposition unit
126 Photoelectric conversion unit and transceiver
811 Power supply unit
812 Power feeding light transmission unit
813 Transceiver
814 Communication circuit
821 Photoelectric conversion unit
822 Secondary power supply
823 Transceiver
824 Communication circuit

1. A communication device comprising:
a power feeding light transmission unit that transmits power feeding light to an opposing communication device;
a measurement unit that measures an optical loss value in transmission of the power feeding light from an own device to the opposing communication device; and
a control unit that controls output of the power feeding light transmitted from the power feeding light transmission unit according to the optical loss value measured by the measurement unit.

2. The communication device according to claim 1, wherein the measurement unit measures the optical loss value using an optical pulse tester, and
the control unit controls the output of the power feeding light to be larger as the optical loss value is larger.

3. The communication device according to claim 1, wherein:
the power feeding light transmitted from the power feeding light transmission unit is transmitted to each of the plurality of opposing communication devices via a branching unit;
the measurement unit measures each of the optical loss values in transmission of the power feeding light from the own device to the plurality of opposing communication devices; and
the control unit controls the output of the power feeding light according to the plurality of optical loss values measured by the measurement unit.

4. The communication device according to claim 3, wherein
the control unit controls the output of the power feeding light to be maximized in a case where at least one of the plurality of optical loss values measured by the measurement unit is equal to or greater than a predetermined value, and controls the output of the power feeding light to be an output value obtained by adding a maximum value of the plurality of optical loss values to a preset output value in a case where all of the plurality of optical loss values measured by the measurement unit are less than the predetermined value.

5. An optical power feeding system comprising a first communication device and a second communication device, wherein:
the first communication device includes
a power feeding light transmission unit that transmits power feeding light to the second communication device,
a measurement unit that measures an optical loss value in transmission of the power feeding light from the first communication device to the second communication device, and
a control unit that controls output of the power feeding light transmitted from the power feeding light transmission unit according to the optical loss value measured by the measurement unit; and
the second communication device includes
a power feeding light reception unit that receives the power feeding light transmitted from the first communication device,
a photoelectric conversion unit that converts the power feeding light received by the power feeding light reception unit into power, and
a power storage unit that stores the power converted by the photoelectric conversion unit.

6. The optical power feeding system according to claim 5, wherein:
the second communication device further includes a power storage state information transmission unit that transmits first power storage state information indicating a power storage state of the power storage unit to the first communication device;
the first communication device further includes a power storage state information acquisition unit that acquires the first power storage state information transmitted from the power storage state information transmission unit; and
the control unit controls the output of the power feeding light transmitted from the power feeding light transmission unit according to the first power storage state information acquired by the power storage state information acquisition unit.

7. The optical power feeding system according to claim 6, wherein the power storage state information transmission unit transmits the first power storage state information superimposed on reflected light of the power feeding light.

8. The optical power feeding system according to claim 7, wherein:
the second communication device further includes a communication light transmission unit that transmits second power storage state information to the first communication device by communication light;
the first communication device further includes a communication light reception unit that receives the second power storage state information transmitted from the second communication device;
the power storage state information transmission unit transmits the first power storage state information to the first communication device in a case where the power feeding light reception unit receives the power feeding light;
the communication light transmission unit transmits the second power storage state information to the first communication device in a case where the power feeding light reception unit does not receive the power feeding light; and
the control unit controls the output of the power feeding light according to the power storage state information acquired by the power storage state information acquisition unit or the communication light reception unit.

9. (canceled)

10. An optical power feeding method in an optical power feeding system including a first communication device and a second communication device, the optical power feeding method comprising:
a power feeding light transmission step in which the first communication device transmits power feeding light to the second communication device;
a measurement step in which the first communication device measures an optical loss value in transmission of the power feeding light from the first communication device to the second communication device;
a control step in which the first communication device controls output of the power feeding light according to the optical loss value measured by the measurement step;
a power feeding light reception step in which the second communication device receives the power feeding light transmitted from the first communication device;
a photoelectric conversion step in which the second communication device converts the power feeding light received by the power feeding light reception step into power; and
a power storage step in which the second communication device stores the power converted by the photoelectric conversion step.
